(19) United States
(12) Patent Application Publication
(10) Pub. No.: US 2008/0179139 A1
(43) Pub. Date: Jul. 31, 2008

(54) OIL CHANGE APPARATUS

(75) Inventor: James Leonard Montgomery, Dubuque, IA (US)

Correspondence Address: BAKER & DANIELS LLP, 300 NORTH MERIDIAN STREET, SUITE 2700, INDIANAPOLIS, IN, 46204, US

(73) Assignee: Deere & Company, Moline, IL (US)

(21) Appl. No.: 11/668,905

(22) Filed: Jan. 30, 2007

(51) Int. Cl. F16N 33/00

(52) U.S. Cl. 184/1.5

(57) ABSTRACT

The instant invention relates to a automatic oil change apparatus and system for an internal combustion engine. The apparatus is equipped with a non-volatile memory for receiving data from and transmitting data to the engine controller.

### BACKGROUND OF THE INVENTION

Internal combustion engines of the 4-stroke variety are lubricated by circulating oil from a crankcase reservoir. Because of an accumulation of combustion products making their way past the piston rings into the crankcase, metal shavings, oil chemistry changes, and a breakdown of oil ingredients such as viscosity modifiers replacement of used oil with new oil extends engine life.

Continuous oil change systems are known such as described in U.S. Pat. No. 5,749,339. Used oil is removed continuously from the engine lubrication system and added to the engine fuel for combustion in the engine. New oil from a reservoir replaces the combusted used oil. The continuous oil change system enables a change of oil while the engine continues in operation.

Batch oil change systems that enable a change of oil while the engine continues in operation are also known. U.S. Pat. No. 3,447,636 discloses a batch oil change system that makes use of a single housing volume divided by a bellows into separate chambers. Used oil under the pressure of the engine lubrication system displaces new oil from the housing by expanding the chamber bellows.

U.S. Pat. No. 6,585,009 discloses a batch oil change system of an out-of-service engine. The system employs a controller to record engine information and programs oil changes as a function of fuel consumption.

U.S. Pat. No. 5,881,688 discloses a continuous oil change system for an engine in-service whereby used oil is combined with fuel and combusted.

The foregoing referenced patents are incorporated herein by reference.

### SUMMARY OF THE INVENTION

The instant invention is directed to an oil change system operable on a continuous or batch basis for changing engine oil for an engine in operation. The system may employ a positive displacement of new oil from a chamber incorporating concatenated bladders separating new oil from used oil. The system also comprises a non-volatile memory which down loads engine data from the engine controller and data related to the date/time of the oil change, oil consumption and other oil related parameters as described. The chamber and non-volatile memory are incorporated into a removable unit that may be connected hydraulically to the engine oil lubrication system and electrically to the engine controller. To the engine data, there may be added to the non-volatile memory data regarding the condition of the used oil. Accumulated data in the non-volatile memory may be transmitted to a remote file server when the removable unit is serviced by recharge with new oil and used oil is collected for disposal. Engine data such as load factors, rpm histograms, and malfunction episodes may be transferred from the engine controller to a remote server by download the non-volatile memory device.

### BRIEF DESCRIPTION OF THE DRAWINGS

FIG. 1 represents a housing and appurtenant connections useful for an automated oil change system with digital data collection.

FIG. 2 represents a housing and appurtenant hardware showing a partial accumulation of used oil in a used oil chamber.

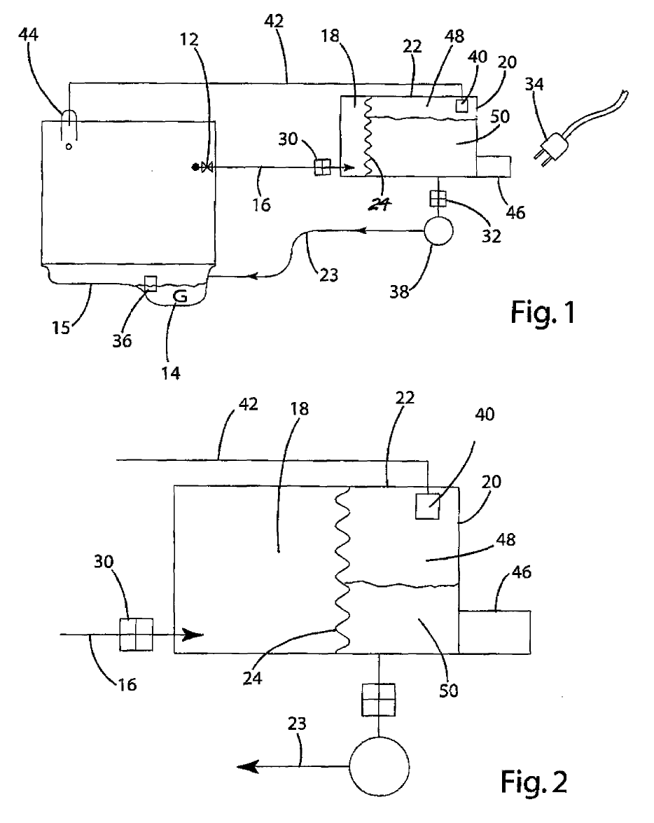

### DESCRIPTION OF INVENTION

Internal combustion engines of the 4-cycle variety utilize a crankcase, a sump, and a pressurized system to circulate lubricating oil within the engine. During use, the utility of oil as a lubricant deteriorates due to the accumulation of combustion-generated compounds, debris, acid, and metallic particles generated from wear of engine parts. Further the lubricity of the oil is compromised by the thermally induced degradation of molecular weight and corresponding reduction of viscosity. Engine life is extended by periodic exchange of used oil for new oil.

For some applications for which internal combustion engines are employed, continuous and uninterrupted operation is essential. For example, use of internal combustions engines to power a natural gas pumping station, or to power electric generators. In such applications stopping the engine for service including a change of lubrication oil requires additional/backup equipment be brought on line to continue uninterrupted service or alternatively, an interruption of service. A savings of invested capital for backup equipment may be realized by incorporating a change of lubricating oil while the engine is in operation.

The instant invention provides a system for exchanging used oil for new oil without interruption of engine use.

The instant invention provides a system for exchanging used oil for new oil employing a reservoir or chamber to contain new oil that may also receive used oil by separating the two fluids by means of a flexible membrane.

The instant invention provides an engine controller generated signal to initiate a change of oil when a preprogrammed condition occurs.

The instant invention provides a means of collecting engine performance data.

The instant invention provides a means for collecting oil performance data.

These and other objectives and advantages will be apparent from the description that follows.

Generation of a signal by the engine controller to change oil may be based upon a variety of parameters considered individually, or as a combination of factors accumulated to an algorithm programmed in the engine controller. Such parameters include by way of illustration: engine revolutions since the last prior partial or batch oil change, sensor derived pH, volume of fuel consumed as measured by the vehicle fuel system, a combination of severity of use and accumulated engine revolutions, or combinations of these or other factors. Advantageously engine manufactures may identify relevant information from that available from engine controllers and generate algorithms programmed into the engine controllers that are relevant to the longevity of the engine.

In one embodiment of a concatenated chamber, when the preprogrammed condition is met, the engine controller (not shown) initiates a batch oil change by checking that the oil level in the crankcase 15 meets a prescribed level. If crankcase oil level is at the prescribed level, the controller signals to valve 12 to divert a measured portion of the oil pressurized by the crankcase oil pump 14 through conduit 16 to used oil chamber 18 of housing 20. Alternatively, a positive displacement pump may be employed to move used oil to the used oil chamber.

The controller actively maintains a predetermined level of lubricating oil in the crankcase. Sensors for determining the oil level of an engine in operation have been described as for example in U.S. Pat. No. 4,495,909, incorporated herein by reference. The oil level may fall below a predetermined level for reasons such as leakage, or oil consumption by the engine. When the crankcase oil sensor 36 identifies that the oil level is below the prescribed level, then the controller signals a positive displacement pump 38 to transfer new oil from new oil from chamber 22 to the crankcase 15.

During a batch oil change, if the controller receives a signal from crankcase oil level sensor 36 that the crankcase oil level does not meet the level required, then the engine controller loops with a time/engine-hour delay to permit the positive displacement pump 38 to transfer new oil from chamber 22 to the crankcase through conduit 23 sufficient to raise the oil level to the prescribed level before a next diversion of a measured portion of used oil is transferred to used oil chamber 18.

To complete a batch oil change, the controller generates a signal to repeat the sequence to cause a second and subsequent measured portions of used oil from the crankcase to be transferred to chamber 18 when permitted by the signal from the crankcase oil level sensor, and as often as necessary until the volume of used oil prescribed for a batch oil change is transferred to chamber 18.

In a manual oil change with an engine out of service the entire crankcase contents of old oil would be removed and a prescribed volume of new oil added to replace the same, often with an additional incremental volume to provide a margin of safety for oil consumption or leakage. For a batch change of used oil for new oil according to the instant invention, it is anticipated that a volume of oil corresponding to the prescribed volume of oil would be removed to the used oil chamber 18. It will be recognized that as an engine operates, that a removal of the entire volume of used oil and replacement with a volume of new oil as occurs with a manual oil change with an out of service engine is not possible, as new oil will be diluted with the used oil.

As a continuous oil change system, it is meant that rather than replacing used oil by repeated transfers of new and used oil in rapid succession as permitted by signals from the crankcase oil sensor, the controller repeats the sequence by changing small amounts of used oil for new oil interspersed by intervals of engine operation.

Separate rigid housings may be employed for new oil and for used oil. A space savings may be realized by concatenating the new and used oil chambers.

Ideally, the volume of new oil and volume of used oil would be the same, whereupon used oil chamber 18 would displace the concatenated chamber 20 as new oil is pumped from chamber 22 and used oil fills chamber 18. Engine oil consumption, and oil leakage may reduce the volume of used oil relative to the new oil. The volume of crankcase oil may increase under cold climate operating conditions, as unburned fuel may leak into the crankcase diluting the lubricating oil and increasing the volume thereof. A further volume difference may be caused by temperature. Hydrocarbon oil has a coefficient of thermal expansion on the order of 6×10⁻⁴/° C. Temperature differences between used oil, which in an operating engine may approach 100° C., and ambient new oil may contribute to volume differences between the volume of used oil entering chamber 18 and the volume of new oil pumped from chamber 22 to crankcase 15. To accommodate the volume differences there is provided a gas vent 40, in the new oil chamber 22 to permit a space 48 above the liquid volume of new oil 50 to equilibrate with the atmosphere. Volume adjustment in the used oil chamber 18 is accommodated by displacing the separator 24 into the new oil chamber. Venting the chamber to atmosphere would be functional. Environmental concerns may necessitate venting the chambers in a manner calculated to reduce emission of hydrocarbons to the atmosphere, such as a connection to the engine intake air system 44, through conduit 42.

Chamber 18 for used oil is separated from chamber 22 for new oil by a barrier such as a flexible membrane 24 optionally shaped as a bellows. Alternatively, the chamber may be conveniently configured as a cylinder and the new oil chamber 22 and used oil chamber 18 separated by a piston. New oil chamber 22 is sized such that the volume of new oil therein is sufficient to meet any need to maintain a predetermined oil level in the crankcase as a result of oil leakage or combustion between oil changes and sufficient to fill the engine crankcase to the appropriate level. The flexible chamber barrier may comprise a resilient material such as a thermoplastic elastomer having a melt temperature above the operating temperature of used oil. Polyether elastomers provide such properties, such as products offered under the Arnitel® mark by DSM, J H Heerlen, The Netherlands. Silicon rubbers may also be useful as barriers.

Upon completion of the oil change, the housing containing now used oil and the non-volatile memory may be removed from the engine. Removal may be facilitated by known quick-disconnect couplings 30, 32 that incorporate valves preventing loss of oil from the chambers upon removal of the housing and an electrical connection, preferably of a plug type, 34 to the engine controller. Optionally, a standardized housing 20 that connects to a variety of engine types and sizes may be developed.

Presently engine controllers accumulate revolution data. It is customary that accumulated revolutions are counted in “hours”. As used, “hours” measure the accumulated number of hours that an engine has operated at an assumed speed, stated generally in revolutions per minute, rpm. For example, an engine may accumulate hours at 1500 rpm. If the engine operates at 750 rpm for one hour, then one-half hour at a 1500 rpm basis will be accumulated. Additional data available to the controller for accumulation may include the severity of engine service, e.g., has the engine operated at maximum load, or ½ maximum load etc., has the load been constant, or was the engine subjected to repeated acceleration/deceleration cycles?

The signal to initiate an oil change generated by the engine controller may result from an algorithm incorporating some or all of the data accumulated by the engine controller. For example, the algorithm may be a function of accumulated hours multiplied by a factor related to the maximum load. Optionally, oil properties such as sensor measured pH, may be incorporated in the algorithm.

The volume of new oil remaining in the new oil chamber 22, may be measured by accumulation of the measured portions pumped from the new oil chamber 22 to the crankcase by the positive displacement pump 38, or by an level sensor, not shown, in the new oil chamber 22. When the volume of new oil in the new oil chamber is lowered to a designated level the controller may signal operator that a change of the housing 20 is required. If the signal is not acted upon, and after appropriate warnings, the controller may be programmed to shut down the engine, to avoid excessive engine wear. Or alternatively, the owner/operator may call for the controller to be programmed to continue operation of the engine at the expense of accelerated wear, where for example the engine provides essential power that will cause significant disruption if the engine operation is discontinued.

A component of the system for automated oil change is a non-volatile memory component 46. Typical of such memory capacity are devices popularly known as a “thumb drive” for connection to Universal Serial Buss (USB) ports of computers. Data storable on the memory portion of the engine controller include the date of the housing is connected to the engine, the oil type, manufacturer, and the viscosity.

Typical data downloadable from the engine to the non-volatile memory of the oil change system includes the data described above uploaded to the engine controller from the non-volatile memory 46 concerning new oil in the housing, at the time oil housings are exchanged, the date and/or hours of operation of the automatic oil change if a batch change, any engine error codes, engine maintenance requirements, engine performance characteristics such as exhaust gas sensor observations, engine serial number, oil pH, the rate of oil consumption by the engine, fuel consumption, engine loading, and accumulated hours. The information transferred may be an integration of measured data, or an accumulation of individual data measurements and corresponding dates or engine hours.

Additional information that may be generated from used oil may be collected when the housing is re-charged. Used oil may be analyzed for acid content, molecular weight distribution, metal content, viscosity, total particulate content, particulate size distribution, etc. Data generated from examination of used oil may be associated with used oil from a particular engine, and associated with oil from a particular source.

At the time the housing is re-charged with new oil, the non-volatile memory may advantageously downloaded to a file server which enables the data from the non-volatile memory of the housing to be correlated with other data. The non-volatile memory of the oil housing may then be charged with appropriate information to upload to the controller of the next engine to which, the housing is affixed pending an automatic oil change.

The system described for the collection of data simplifies data collection by limiting human intervention to a few data inputs, such as: specifics of new oil charged to the new oil reservoir; and the collection and analysis of information from used oil. These data inputs are generated away from the field environment where the engine may be in use, and by individuals regularly engaged in such data entry. The substantial part of the data collected by the system is available for accumulation manually by individuals. However, the individuals available to collect data are often maintenance engineers or operators that may have priorities different than manual collection and assuring the accuracy of data. To be useful, assembly of the data with large volumes of other data, although possible manually, is preferably accomplished by computer. Data collection at the location of engine use enabled by the instant system is advantaged by being automatically generated by the engine controller and stored on the non-volatile memory. Input of data to the non-volatile memory and data collected at the point of new oil recharge of the housing and the input of data from used oil analysis is accomplished in an environment accustomed to such activity, thereby benefits from consistency. Data downloaded from the engine controller and data input when the housing was charged with new oil may be accurately downloaded to a file server by hard wired or wireless connection when the housing is recharged with new oil.

A compilation of data of used oil from a sampling of engines enables evaluation of engine wear characteristics, the lubricity and life of oil offerings of various manufacturers, the impact of frequency of oil changes, and other data that affords a manufacturer a basis by which to establish oil change intervals as well as other service intervals. In cooperation with lubrication oil suppliers, the data may be correlated with development efforts for lubricant improvements.

While the system described has advantages related to the ease and accuracy of data collection, the timeliness of oil changes and a corresponding extended useful engine life, it may not be adopted by all engine owners or users of engines. The system also provides an opportunity for an engine manufacturer to incentivize customers and users of engines to adopt the automatic system for oil changes. For example, extended warranties may be offered for use of the described automated oil change system because it establishes a record that the oil change occurs consistent with the manufacturers recommendations. The data collected by the non-volatile memory, particularly when assembled with comparable data from a plurality of engines, and a plurality of data from a series of oil change events from engines affords access to a computerized database useful for the identification of opportunities to improve engine performance and useful life.

Implementation of the claimed invention by equipment owners, operators, and leasing enterprises may prolong the useful life of engine powered equipment. Documentation of timely oil changes may result in reduced depreciation in market value of used equipment.

What is claimed is:

1. An oil change system for an internal combustion engine comprising:
an engine controller;
a housing separable from the engine providing two or more chambers;
a first said chamber for receiving new oil;
a second said chamber for receiving used oil;
providing with said housing a non-volatile memory capable of communication with the engine controller for transmitting data related to engine operation to the non-volatile memory.

2. The oil change system of claim 1 wherein data related to new oil may be transferred from the non-volatile memory to the engine controller.

3. The oil change system of claim 1 wherein the data from the non-volatile memory is transferred to a file server.

4. The oil change system of claim 3 wherein the data from the non-volatile memory is assembled with other data to identify trends with respect to one or more factors from the group consisting of: engine life; engine wear characteristics; oil performance; oil lubricity; oil chemistry; engine error code; oil consumption, fuel consumption.

5. The oil change system of claim 3 wherein the file server is located at a location remote from the oil change location.

6. The oil change system of claim 4 wherein the data is transferred to a file server by means of a direct connection by a wireless, or wired interface.

7. The oil change system of claim 4 wherein the data is transferred to a file served by means of an internet connection.

8. An oil change system for an internal combustion engine comprising:
an engine controller;
a housing separable from the engine providing two concatenated chambers;
a first said chamber for receiving new oil;
a second said chamber for receiving used oil;
said chambers having a volume variable by means of a separator;
providing with said housing a non-volatile memory capable of communication with the engine controller for transmitting data related to engine operation to the non-volatile memory.

9. The oil change system of claim 8 data related to new oil charged to the housing may be transmitted to the engine controller.

10. The oil change system of claim 8 wherein the data from the engine controller including data from any one or more of the group consisting of data concerning oil last charged to the housing; date or engine hours since last previous batch oil change; engine error codes, engine maintenance requirements, engine performance characteristics engine serial number, oil pH, lubricating oil consumption rate; accumulated engine hours; fuel consumption rate; severity of engine load, from the non-volatile memory is transferred to a file server.

11. The oil change system of claim 10 wherein the data from the non-volatile memory is assembled with other data from any one or more of the group consisting of data concerning: engine wear characteristics; oil performance; oil lubricity; oil chemistry; oil source; oil specifications.

12. The oil change system of claim 11 wherein the data is assembled on a the file server located at a location remote from the oil change location.

13. The oil change system of claim 12 wherein the data is transferred to a file server by means of a direct connection by a wireless, or wired interface.

14. The oil change system of claim 4 wherein the data is transferred to a file served by means of an internet connection.

15. An oil change housing separable from an engine comprising two;
a first said chamber for receiving new oil;
a second said chamber for receiving used oil;
said housing having a non-volatile memory capable of communication with an engine controller for transmitting data related to engine operation to the non-volatile memory.

16. The oil change housing of claim 15 further wherein the chambers are concatenated chambers having a volume variable by means of a separator.

17. The oil change housing of claim 16 wherein the separator is selected from a bellows style membrane, or a piston.

18. The oil change housing of claim 17 wherein the separator is a bellows comprised of a resilient polymer.

19. A method of transferring data concerning oil for an internal combustion engine between the engine controller and a non-volatile memory comprising:
establishing a communication between the non-volatile memory and the engine controller;
transferring data to the engine controller data concerning oil from the non-volatile memory.

20. The method claim 19 wherein the data transferred may be data concerning new oil uploaded from the non-volatile memory to the controller, or data concerning used oil downloaded from the controller to the non-volatile memory.
